(19) United States
(12) Patent Application Publication
(10) Pub. No.: US 2026/0143563 A1
(43) Pub. Date: May 21, 2026

(54) NETWORK-ASSISTED EMERGENCY CONNECTIONS FOR UE TO SECURE WIFI NETWORKS

(71) Applicant: T-MOBILE INNOVATIONS LLC, Overland Park, KS (US)

(72) Inventors: Manikanta Kumar Teja Penumatsha, Redmond, WA (US); Jenniffer Lucas Cruz, Renton, WA (US); Barbara Maria Elena Diaz Manjarrez, Lynwood, WA (US); Venkata Surya Niranjan Sharma Piratla, Renton, WA (US); Sudhanshu Pandey, Sammamish, WA (US)

(21) Appl. No.: 18/955,686

(22) Filed: Nov. 21, 2024

(51) Int. Cl. H04W 76/50; H04W 12/084; H04W 40/20

(52) U.S. Cl. CPC H04W 76/50; H04W 12/084; H04W 40/20

(57) ABSTRACT

Systems, methods, and software are disclosed herein for connecting a call through a wireless access point to an end-user device for wireless communication in various implementations. In one example, a method comprises receiving a call to an end-user device that is proximate to, but unauthorized with respect to, a wireless access point associated with an access service provider; requesting the access service provider to grant access through the wireless access point to the end-user device; and connecting the call through the wireless access point to the end-user device.

### TECHNICAL FIELD

Aspects of the disclosure are related to the field of wireless communication networks, particularly calls connecting via wireless access points to wireless communication networks.

### BACKGROUND

When a smartphone initiates an E911 call over an LTE or 5G network, it may use the device's VoLTE (Voice over LTE) or VoNR (Voice over New Radio) capability, where the voice call is transmitted as IP-based data packets over the carrier's core IP Multimedia Subsystem (IMS). For LTE networks, the device connects to the Evolved Packet Core (EPC) network infrastructure, which supports both data and voice, while in 5G networks, the call may traverse the 5G Core (5GC) if the carrier's infrastructure supports full standalone 5G. Once the E911 call is initiated, the network prioritizes the call, routing it directly to a Public Safety Answering Point (PSAP).

When a cellular signal is undetectable, a user may connect to an available WiFi network to maintain communication capabilities. Integrating Voice over WiFi (VoWiFi) with a cellular carrier's infrastructure involves linking WiFi calling capabilities to the carrier's core IMS network, which manages both voice and data services across different network types. By connecting to WiFi, the user can access services like VoWiFi for calls, messaging, and internet access, as the WiFi network provides a pathway for data that the cellular network normally handles. Once connected, the smartphone will route voice and data traffic over the WiFi network, allowing the user to place calls, including E911 calls, and use data services as they would on a cellular network.

When an E911 call is placed using VoWiFi, the call is still routed through the carrier's IMS infrastructure but travels over an IP-based WiFi network rather than a cellular network. However, this connectivity is predicated on the ability of a smartphone to access the WiFi network. In a location where there is no cellular signal or available WiFi network, a smartphone is effectively offline, unable to send or receive calls, messages, or data.

### OVERVIEW

Technology is disclosed herein for connecting a call through a protected wireless access point to an end-user device for wireless communication in various implementations. In one example, a method comprises receiving a call to an end-user device that is proximate to, but unauthorized with respect to, a wireless access point associated with an access service provider; requesting the access service provider to grant access through the wireless access point to the end-user device; and connecting the call through the wireless access point to the end-user device.

In another example, a computing apparatus comprises one or more computer readable storage media, one or more processors operatively coupled with the one or more computer readable storage media and program instructions stored on the one or more computer readable storage media that, when executed by the one or more processors, direct the computing apparatus to receive a call to an end-user device that is proximate to, but unauthorized with respect to, a wireless access point associated with an access service provider; request the access service provider to grant access through the wireless access point to the end-user device; and connect the call through the wireless access point to the end-user device.

In yet another example of the technology disclosed herein, one or more computer readable storage media having program instructions stored thereon that, when executed by one or more processors, direct a computing apparatus to receive a call to an end-user device that is proximate to, but unauthorized with respect to, a wireless access point associated with an access service provider; request the access service provider to grant access through the wireless access point to the end-user device; and connect the call through the wireless access point to the end-user device.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for connecting a call through a protected wireless access point to an end-user device in an implementation.

FIG. 2 illustrates a process for connecting a call through a protected wireless access point to an end-user device in an implementation.

FIG. 3 illustrates a workflow for connecting a call through a protected wireless access point to an end-user device in an implementation.

FIG. 4 illustrates an operational environment for connecting a call through a protected wireless access point to an end-user device in an implementation.

FIG. 5 illustrates a workflow for connecting a call through a protected wireless access point to an end-user device in an implementation.

FIG. 6 illustrates an operational architecture of a wireless communication network in an implementation.

FIG. 7 illustrates an operational architecture for a wireless communication network in an implementation.

FIG. 8 illustrates a computing system suitable for implementing the various operational environments, architectures, processes, scenarios, and sequences discussed below with respect to the other Figures.

### DETAILED DESCRIPTION

Although the descriptions provided herein may be in the context of certain radio access technologies, networks, and network topologies, such as 5G-NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Various implementations are disclosed herein for network functionality by which a call may be connected to an end-user device (e.g., cell phone) via a wireless access point (e.g., WiFi modem) to which the end-user device is unauthorized for access. For example, a cellphone out of range of cellular service but proximate to a password-protected WiFi modem may receive a call from a third party which is routed through the WiFi modem even when the end-user device is not authenticated with respect to the WiFi modem. In various implementations, access to the wireless access point is provided to the end-user device on a limited, temporary basis based on a request by the wireless carrier of the end-user device to the access service provider providing network connectivity for the access point. The request for authorization sent by the wireless carrier to the access service provider may occur during an initial outgoing call by the end-user device which is routed through the WiFi modem or other access point based on a priority or emergency authorization.

In an exemplary scenario, an end-user device (e.g., smartphone) lacking cellular service but proximate to a secured WiFi modem (to which the end-user device is unauthorized) places an Enhanced 911 (E911) call to a Public Safety Answering Point (PSAP) via the WiFi modem. (U.S. Ser. No. 18/802,564 entitled WIFI PROTECTED ACCESS BYPASS FOR EMERGENCY VOICE SERVICES is incorporated herein by reference in its entirety.) During the E911 call, the wireless carrier of the end-user device requests continued access via the WiFi modem from the Internet service provider (ISP) hosting Internet connectivity to the modem, providing credentials for access to the ISP in the request. The access credentials include a device Media Access Control (MAC) address, modem MAC address, modem Internet Protocol (IP) address, and other connectivity information. When the E911 call ends, although the end-user device lacks cell service, the PSAP can place a call-back to the end-user device which will be routed to the device via the WiFi modem based on an authorization by the ISP. In various implementations, the authorization for continued access is time-limited, expiring after a specified period of time (e.g., ten minutes). In the scenario described above, temporary access for receiving call-backs begins when the outgoing call from the end-user device to the PSAP ends. Thus, in an emergency, the wireless carrier has a window of time during which it can route a call-back to the device from the PSAP through the WiFi modem even though the device is not authorized for access through the modem.

In various implementations, an evolved Packet Data Gateway (ePDG) of the wireless carrier coordinates with an access service provider or ISP for continued access of the end-user device to a wireless access point such as a WiFi modem. The ePDG includes functionality for securing handoffs of voice data packets between cellular (e.g., LTE, 5G) networks and WiFi networks, e.g., VoLTE or Vo5G to VoWiFi handoffs. The ePDG may also include functionality for interfacing with an access service provider to receive access device and modem credentials and to provide the credentials when requesting temporary access to a protected wireless access point for an end-user device.

In an implementation, when an E911 call from a smartphone to a PSAP is routed through a WiFi modem, the wireless carrier of the smartphone obtains a token from the ISP of the WiFi modem in accordance with an agreement between the carrier and the ISP. The token includes data keys or access credentials such as the device MAC address, the device International Mobile Subscriber Identity (IMSI), the device International Mobile Equipment Identity (IMEI), the Mobile Station International Subscriber Directory Number (MSISDN) of the device, the modem MAC address, and the modem IP address. During the outgoing call, the wireless carrier sends a request to the ISP for the device to be granted access to the modem for voice calls and provides the access credentials in the form of an encrypted token including the data keys obtained during the outgoing call. In response to the request, the ISP stores the token information in a centralized database and grants temporary access to the WiFi modem for the smartphone.

Continuing the above scenario, when the E911 call from the smartphone ends, the smartphone retains access to the WiFi modem for a specified period of time (e.g., five minutes, ten minutes). During the specified period of time for continued access, the grant of access ensures that if the PSAP places a return call to the smartphone, that the call will be routed to the device via the WiFi modem. When the period of time for continued access ends, the token is invalidated or destroyed, and the smartphone is disconnected from the modem. Thus, although the smartphone may lack cell service and is not authenticated with respect to the WiFi modem, a call may be routed through the modem and terminated to the smartphone based on an emergency or temporary authorization by the ISP in response to a request from the wireless carrier.

Beyond the scenario described above where continued access to the WiFi modem for receiving calls was initiated with an outgoing E911 call from the end-user device, in some implementations of the technology disclosed herein, a wireless carrier may route a call to an end-user device through a wireless access point in other scenarios as well. For example, in attempting to route a high-priority call to the end-user device that is undetectable on the network, the wireless carrier may identify a wireless access point based on historical access patterns of the device and, based on an authorization of an access service provider (e.g., ISP) of the wireless access point, terminate the call to the device via the wireless access point. The wireless carrier may request authorization from the access service provider for access to the wireless access point on behalf of the end-user device by sending an encrypted token of data keys (e.g., device and modem details) to the access service provider. The access service provider may grant access to the wireless access point for the call based on a priority status of the request (e.g., an emergency request, wireless priority access (WPA) call status), on a per-request basis, and/or for an agreed or specified period of time. Thus, the technology provides a mechanism to bypass the normal authentication process for the device to temporarily connect to an otherwise unauthorized WiFi network with the request for access coming from the carrier of the device rather than from the end-user device itself.

Technical effects of the technology disclosed herein include ensuring that, in an emergency, when a PSAP such as a 911 call center receives a E911 call from a user device which is routed through a WiFi modem in the vicinity of the device but which the device is not authorized to use, that the PSAP will be able to contact the user device via the WiFi modem as the circumstances warrant. Enabling the continued access on a time-limited basis ensures that although the device is not authorized for network connectivity through the modem, the integrity of the network hosted by the ISP is protected from misuse. Moreover, the authorization for temporary access is automatic and seamless with respect to the user. Thus, the token-based system provides a straightforward and efficient method to grant devices temporary access to WiFi networks in emergency situations allowing wireless carriers to ensure continuous connectivity for critical services.

More generally, the technology disclosed herein enables a wireless carrier to request authorization for a user device to receive a call via a wireless access point such as a WiFi modem when the user device is not authorized to access the modem. Thus, the technology provides a mechanism to bypass the normal authentication process for the device to temporarily connect to a WiFi network with the request for access coming from the carrier of the device rather than from the device itself. For example, in an emergency, if the user device is not connected to the cellular network, the wireless carrier may still terminate a call to the device by routing the call through a WiFi network of a modem or router in the proximity of the device. The access service provider may grant such access based on a prioritization of the request (e.g., an emergency request or wireless priority access (WPA) call status), on a per-request basis, and/or for an agreed or specified period of time. Here, too, such authorization may be obtained via an exchange of tokens or digital access credentials obtained from the ISP of the modem as part of a pre-arranged agreement between the carrier and the ISP.

The practical advantages of the technology disclosed herein support a number of beneficial scenarios. For example, collaboration between ISPs and carriers to deploy wireless access points in high-traffic areas (e.g., malls, airports) will allow traffic to be offloaded from cellular networks. Wireless carriers can offer premium emergency services using the token system, enhancing customer loyalty and creating new business models. Offloading data from cellular networks to WiFi networks during emergencies reduces strain on edge network infrastructure, lowering operational costs. Token-based access can support public safety initiatives such as improving connectivity in “smart city” environments. ISPs and wireless carriers can form strategic partnerships to enhance service coverage and create bundled offerings for users, driving mutual growth.

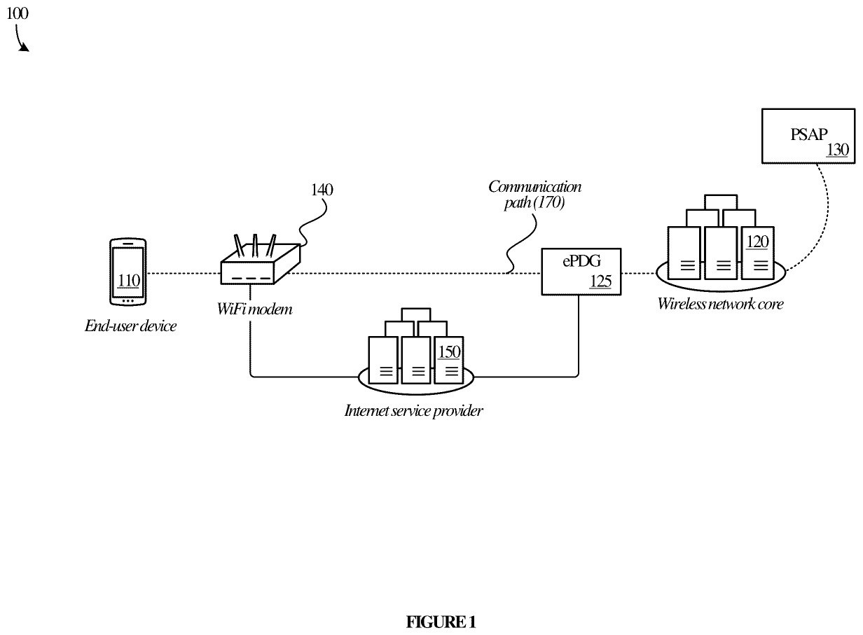

Turning now to the Figures, FIG. 1 illustrates operational environment 100 for connecting calls to an end-user device via a protected wireless access point in an implementation. Operational environment 100 includes end-user device 110, WiFi modem 140, wireless communication network 120 including ePDG 125, Internet service provider 150, PSAP 130, and communication path 170.

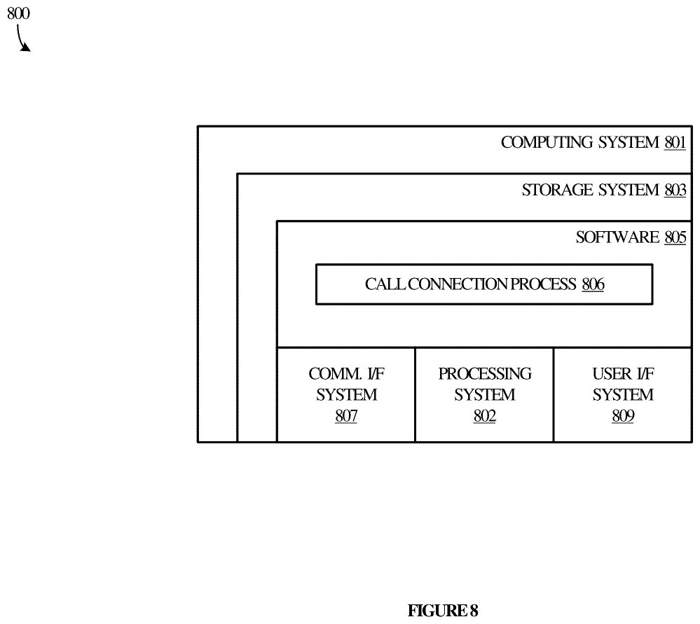

End-user device 110 is representative of user equipment (UE) such as a mobile computing device, such as a smartphone, cellular phone, tablet computer, wearable device, Internet of Thing (IoT) device, or enhanced mobile broadband (eMBB) device, of which computing system 801 in FIG. 8 is representative. End-user device 110 includes processing circuitry for wireless communication including multimedia communication, e.g., IP Multimedia Subsystem (IMS) voice, text, video, or data transmission, hosted by a wireless communication network such as wireless communication network 120. End-user device 110 exchanges wireless communication signals with base stations or access nodes of wireless communication networks over radio frequency (RF) bands according to protocols such as Fifth Generation New Radio (5G-NR), 5G Advanced, 4G/LTE, 6G, Institute of Electrical and Electronic Engineers (IEEE) 802.11 (WiFi), Low-Power Wide Area Network (LP-WAN), Near-Field Communications (NFC), Code Division Multiple Access (CDMA), Frequency Division Multiple Access (FDMA), and Time Division Multiple Access (TDMA).

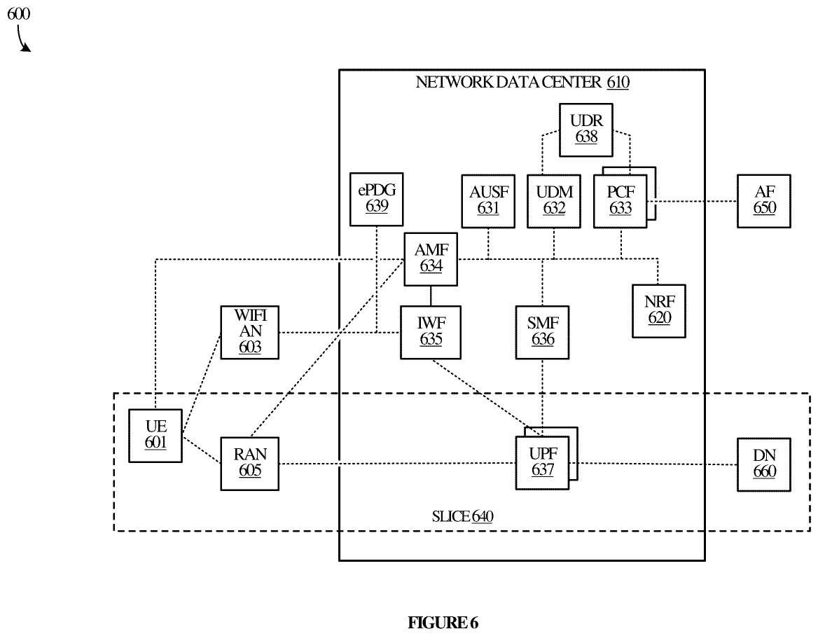

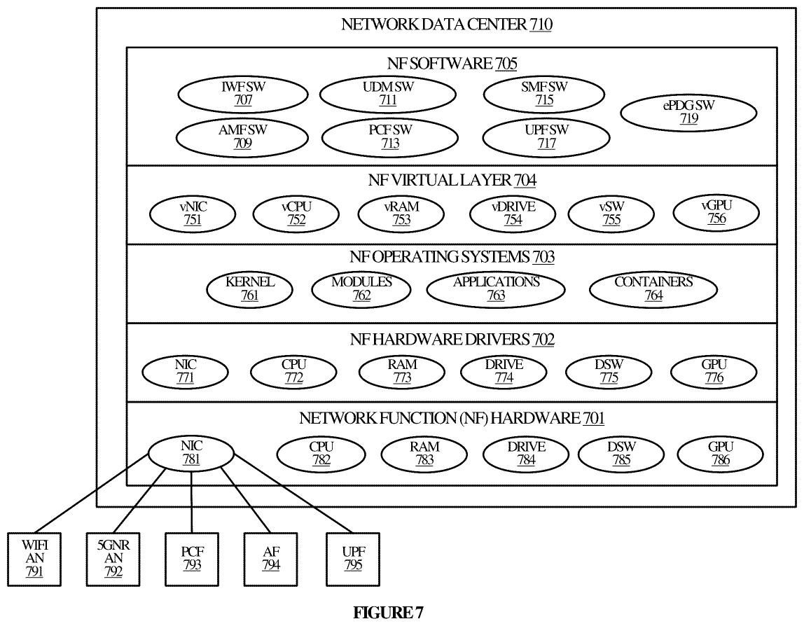

Wireless communication network 120 is representative of a communication network capable of using a Fifth Generation New Radio (5G-NR), 4G LTE, 6G, or other protocol to communicate with devices such as end-user device 110. In an implementation, wireless communication network 120 is representative of a service-based architecture (SBA) which includes network functions which constitute the control plane and user plane of a wireless communication network core, of which network data center 610 of FIG. 6 and network data center 710 of FIG. 7 are representative. Network functions of wireless communication network 120, such as ePDG 125, are implemented on one or more suitable computing devices, of which computing device 801 of FIG. 8 is representative. Examples of suitable computing devices include server computers, blade servers, and the like. The network elements of wireless communication network 120 may be implemented in the context of one or more data centers in a co-located or distributed manner, or in some other arrangement.

Evolved packet data gateway (ePDG) 125 of wireless communication network 120 is representative of a network functionality implemented in software or hardware for securing handoffs of voice data packets between cellular (e.g., LTE, 5G) networks and WiFi networks, e.g., voLTE or vo5G to voWiFi handoffs. In various implementations, ePDG 125 may be located in edge networks or access nodes of a wireless communication network, such as in a gNodeB of a 5G-NR network or an eNodeB of an LTE network. ePDG 125 may include functionality for enabling a call-back functionality for emergency calls from a PSAP or other third party via a wireless access point to an end-user device which is unauthenticated with respect to the wireless access point.

WiFi modem 140 is representative of a computing device that enables access to a wireless network hosted by an ISP, such as ISP 150. WiFi modem 140 facilitates a wireless local area network (WLAN) to enable wireless data communication between connected client devices and a broader communication network, such as the Internet, hosted by an ISP such as ISP 150. WiFi modem 140 may operate by receiving data from a wired or fiber-based Internet connection, converting it into wireless signals using radio frequencies, and broadcasting these signals to allow client devices within range to access network resources. WiFi modem 140 may support protocols compliant with IEEE 802.11 standards, enabling interoperability and high-speed data transfer for client devices. WiFi modem 140 may include security protocols for protected access, such as Wired Equivalent Privacy (WEP), Wi-Fi Protected Access (WPA), WPA2, WPA3, and the like.

ISP 150 is representative of a network service provider that delivers Internet connectivity and network resources to client devices through a wireless access point such as WiFi modem 140. ISP 150 may be an ISP or other entity that supplies access to a broader communication network, enabling wireless data communication for connected devices within a local area network (LAN). ISP 150 may include a centralized database for storing access credentials or tokens for authorizing access by a device such as end-user device 110 to a wireless access point such as WiFi modem 140.

PSAP 130 is representative of a computing device with functionality for placing or receiving a call to/from a mobile device such as end-user device 110. Communication path 170 is representative of the transmission path of an IMS call between end-user device 110 and PSAP 130, such as a call-back by PSAP 130 to end-user device 110. Communication path 170 may include a number of intermediate elements or connection links which are not shown for ease of illustration. For example, a call to/from end-user device 110 routed through WiFi modem 140 may connect through ISP 150 to a broader communication network (e.g., the Internet) to a radio access node hosting ePDG 125 of wireless communication network 120.

In a brief operational scenario of operational environment 100 demonstrating the technology disclosed herein, end-user device 110 is in a location where cellular signal range is unavailable or undetectable. End-user device 110 is in the vicinity of a wireless network of WiFi modem 140 but is not authorized with respect to (e.g., not logged into) WiFi modem 140. For example, WiFi modem 140 may be a private, password-protected WiFi network which end-user device 110 is not authorized to use but in a location where end-user device 110 is unable to pick up a cellular signal. A critical situation arises prompting the user of end-user device 110 to place an E911 call which is routed to PSAP 130 via WiFi modem 140 (for example, per a temporary emergency authorization) and wireless communication network 120.

During the initial, outgoing call to PSAP 130, wireless communication network 120 may receive a token from ISP 150 including access credentials (e.g., addresses and identifiers associated with end-user device 110 and WiFi modem 140). Wireless communication network 120 may also capture connection details such as the MAC address of WiFi modem 140 from the SIP INVITE message and the MAC address of end-user device 110 based on its IMEI. ePDG 125 may authenticate end-user device 110 with a Home Subscriber Service (HSS) or Authentication, Authorization, and Accounting server (AAA) of wireless communication network 120. ePDG 125 sends a request to ISP 150 to grant continued access by end-user device 110 to WiFi modem 140 for a brief window of time commencing when the outgoing emergency call ends. The request includes the token including the access credentials. ISP 150 stores the token in a centralized database and authorizes WiFi modem 140 to maintain connectivity for emergency calling including connecting calls to end-user device 110, such as a call-back from PSAP 130.

In various implementations, the authorization for continued access by end-user device 110 to WiFi modem 140 continues for a predetermined period of time (e.g., ten minutes) commencing from the time that the outgoing call made by end-user device 110 ends. Thus, if necessary, PSAP 130 can place a call-back to end-user 110 if/when the initial emergency call ends. To restrict the time for continued access, the token includes a timer which runs for the predetermined window of time beginning when the outgoing call from end-user device 110 ends. When the inbound call (i.e., the call to end-user device 110) is received, ISP 150 determines whether the window of time for access has expired. If the window has not expired, WiFi modem 140 routes the call to end-user device 110. In some instances, ISP 150 may further restrict calls to/from end-user device 110 which are carried by WiFi router 140 to emergency calls from/to PSAP 130. When the timer expires, the token for continued access is invalidated, and the continued connectivity between end-user device 110 and WiFi modem 140 is ended. To disconnect access to WiFi modem 140 by end-user device 110 when the token expires, ISP 150 may deauthorize end-user device 110 with respect to WiFi modem 140. In some instances, when the token expires, ePDG 125 will no longer route calls through WiFi modem 140.

In some implementations of the technology disclosed herein, to authenticate end-user device 110 with WiFi modem 140, during the outgoing call (to PSAP 130), wireless communication network 120 or ePDG 125 of wireless communication network 120 requests and receives a temporary access token including the device and modem credentials (i.e., addresses, identifiers) for end-user device 110 and WiFi modem 140 from ISP 150. The access token may be restricted to allowing only mobile-originating or mobile-terminating E911 calls for a limited period of time. Wireless communication network 120 then transmits the access token to end-user device 110 through its connectivity with WiFi modem 140 during the outgoing call. End-user device 110 then validates the access token with WiFi modem 140 to maintain its connectivity for receiving any call-backs from PSAP 130 or for placing new calls to PSAP 130. When the outgoing call ends, the access token enables the continued access to WiFi modem 140 for emergency communications for the specified period of time. Thus, if PSAP 130 places a call to end-user device 110 during the period of continuing access, the call may be routed to end-user device 110 via WiFi modem 140.

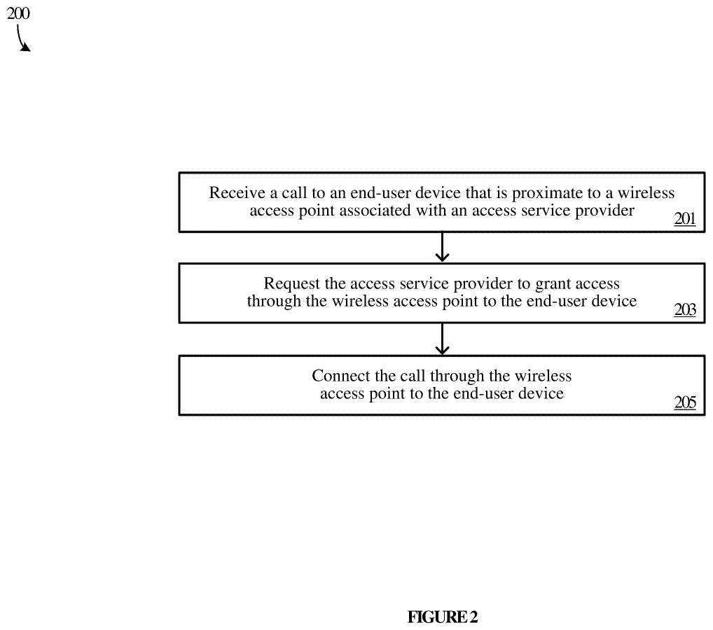

FIG. 2 illustrates a method for connecting calls to an end-user device via a protected wireless access point for wireless communication in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, the computing device receives a call to an end-user device that is proximate to a wireless access point associated with an access service provider (step 201). In an implementation, a computing device, such as an ePDG of a wireless communication network, receives a voice call to an end-user device which is subscribed to the wireless communication network. However, the end-user device is unable to connect to the wireless communication network, e.g., due to being out of cellular signal range. Further, the end-user device is in the proximity of a password-protected network of a wireless access point but lacks the credentials to connect to the wireless access point.

The computing device requests the access service provider to grant access through the wireless access point to the end-user device (step 203). In an implementation, the computing device issues a token to the access service provider of the wireless access point to request access by the end-user device to the wireless access point for mobile-terminating and mobile-originating E911 calls. The token specifies a device address, a modem address, and other identifying information for enabling connectivity between the end-user device and the wireless access point. In some implementations, the token may also be time-limited, including a timer or time limit at the expiration of which the temporary access is to be disabled.

In some scenarios of process 200, if the wireless communication network is unable to detect the smartphone (or other end-user device) on the network when attempting to route a call (e.g., an emergency call) to the smartphone, the wireless communication network identifies a wireless access point (e.g., WiFi modem) through which to route the call to the smartphone. To identify such a wireless access point, the wireless communication network may consult a database of historical access information for the smartphone to determine a likely wireless access point through which to successfully route the call. The database maintained by the wireless communication network may include connection details (e.g., addresses and identifiers) for the most recent, the most frequent, or preferred WiFi connections of the user device. In some scenarios, the database may include WiFi modem MAC addresses and associated WiFi positioning or location information to identify a WiFi modem closest to the last known location of the end-user device. Based on a pre-existing agreement between the wireless communication network and the ISP hosting service to the identified wireless access point, the wireless communication network transmits an access token to the ISP in a request to connect the wireless access point to smartphone to receive the call. Thus, irrespective of whether the smartphone is able to connect to or is in fact connected to the wireless access point, the wireless communication network can route a call to the smartphone on at least a temporary, emergency, or priority basis.

The computing device connects the call through the wireless access point to the end-user device (step 205). In an implementation, the computing device routes the call through the wireless access point to the end-user device during the period of time that the end-user device has been granted continued access to the wireless access point. In connecting the call to the end-user device, a communication link is established to complete a communication path between the calling endpoint and the called device by routing the call through the wireless access point. When the period of time for continued access expires, the token is invalidated, and the wireless access point disconnects the access of the end-user device.

Referring again to FIG. 1, a brief example of process 200 as employed by elements of operational environment 100 follows. In operation, an outgoing call from end-user device 110 to PSAP 130 is carried along communication path 170. End-user device 110 lacks credentials (e.g., a password) for access to WiFi modem 140, so the outgoing call is routed from end-user device 110 through WiFi modem 140 on the basis of a temporary, emergency authorization. WiFi modem 140 which hosts network connectivity via ISP 150. During the outgoing call, ePDG 125 of wireless communication network 120 requests and receives a token from ISP 150 for continuing access by end-user device 110 to WiFi modem 140; the access token enables continuing access (e.g., for a specified period of time) by end-user device 110 to WiFi modem 140 after the outgoing call ends. The access token includes the addresses and identifiers of end-user device 110 and WiFi modem 140.

In step 201, ePDG 125 of wireless communication network 120 receives an inbound voice call to end-user device 110 (e.g., a smartphone) which is subscribed to wireless communication network 120. End-user device 110 is unable to connect to an access node of wireless communication network 120 (e.g., due to weak cellular signal at the location of the smartphone). In addition, end-user device 110 detects the Service Set Identifier (SSID) broadcasted by WiFi modem 140 in the vicinity of end-user device 110 but lacks the credentials for connecting to WiFi modem 140. WiFi modem 140 connects with ISP 150 to provide Internet service to connected devices.

Continuing with the above exemplary scenario, in step 203, ePDG 125 requests access to WiFi modem 140 from ISP 150 hosting Internet service to WiFi modem 140. The request is made on behalf of end-user device 110 for end-user device 110 to at least receive an emergency call-back from PSAP 130 through WiFi modem 140. However, in some scenarios the grant of access may be broader, such as allowing end-user device 110 to make and receive emergency calls with respect to PSAP 130. In the request for access, ePDG 125 issues a token which includes the device MAC address, modem MAC address, modem IP address, and other connection details. The token may also include a timer for time-limiting access by end-user device 110 to WiFi modem 140 for at least receiving emergency calls. In some implementations, step 203 occurs before step 201 so that the request by ePDG 125 for access to WiFi modem 140 by end-user device 110 is made prior to receiving a call-back from PSAP 130.

In various implementations, to issue the token, ePDG 125 receives or captures connection details (e.g., device MAC address, modem MAC address, modem IP address, etc.) from ISP 150 hosting network connectivity to WiFi modem 140. For example, ePDG 125 may obtain the connection credentials from ISP 150 during an emergency call made from end-user device 110 that is routed through WiFi modem 140 (due to the unavailability of cellular service, for example). ePDG 125 sends the token including the connection details to ISP 150 in a request for continued access by end-user device 110 to the WiFi network hosted by WiFi modem 140. Upon receiving the token, ISP 150 authorizes WiFi modem 140 to allow calls to/from end-user device 110 to be carried by WiFi modem 140. The window of time for continued access may be enforced by ISP 150 which causes WiFi modem 140 to end the continued access when the token timer expires.

Continuing with the exemplary scenario above, in step 205, end-user device 110 receives the callback from PSAP 130 via its connection to the WiFi network broadcasted by WiFi modem 140. When the 10-minute window of continued access expires, WiFi modem 140 disconnects end-user device 110 from the WiFi network.

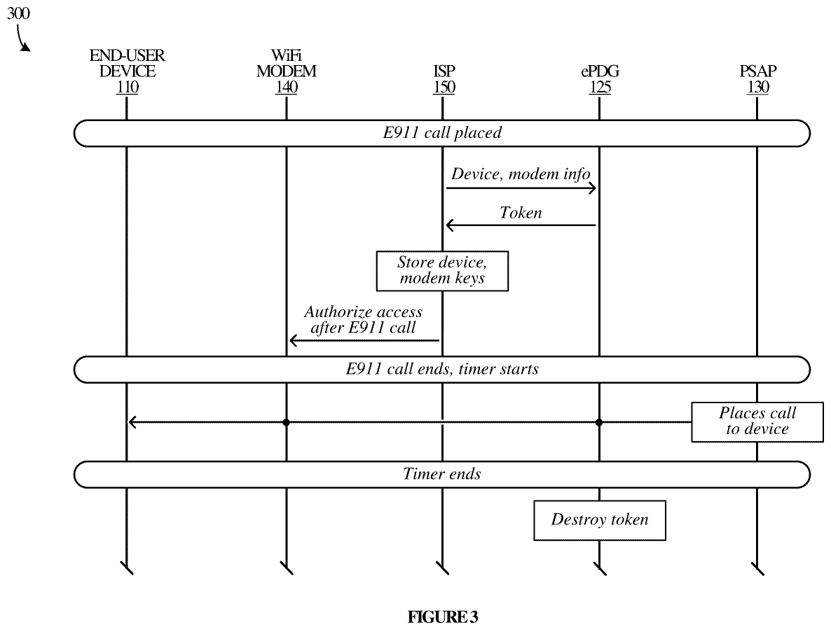

FIG. 3 illustrates workflow 300 for connecting calls through an unauthorized wireless access point in an implementation, referring to elements of FIG. 1. In workflow 300, an E911 call is placed from end-user device 110 to PSAP 130. End-user device 110 lacks credentials (e.g., a password) for access to WiFi modem 140, so the outgoing E911 call may be routed from end-user device 110 through WiFi modem 140 (thence to ePDG 125) on the basis of a temporary, emergency authorization by ISP 150 which is hosting Internet service to WiFi modem 140.

During the outgoing call, ePDG 125 requests and receives access token from ISP 150 for continuing access by end-user device 110 to WiFi modem 140 at the end of the outgoing call. The access token includes access credentials such as the addresses and identifiers of end-user device 110 and WiFi modem 140. After receiving the access token, ePDG 125 requests access to WiFi modem 140 from ISP 150. The request is made on behalf of end-user device 110 for end-user device 110 to at least receive an emergency call-back from PSAP 130 through WiFi modem 140. However, in some scenarios the grant of the requested access may be broader, such as allowing end-user device 110 to make and receive emergency calls with respect to PSAP 130. In the request for access, ePDG 125 issues the access token which includes the device MAC address, IMSI, IMEI, and MSISDN; modem MAC address and IP address; and other connection details. The token may also include a timer for limiting the amount time for access by end-user device 110 to WiFi modem 140 for at least receiving emergency calls. Upon receiving the token, ISP 150 stores the access token in a database and authorizes WiFi modem 140 to allow calls to/from end-user device 110 to be carried by WiFi modem 140.

When the E911 call originating from end-user device 110 ends, the timer on the access token begins to run. During that time, ePDG 125 receives a call to end-user device 110 (e.g., a smartphone) from PSAP 130 and routes the call to end-user device 110. End-user device 110 receives the call-back from PSAP 130 via its connection to the WiFi network broadcasted by WiFi modem 140. When the timer expires, WiFi modem 140 disconnects end-user device 110 from the WiFi network.

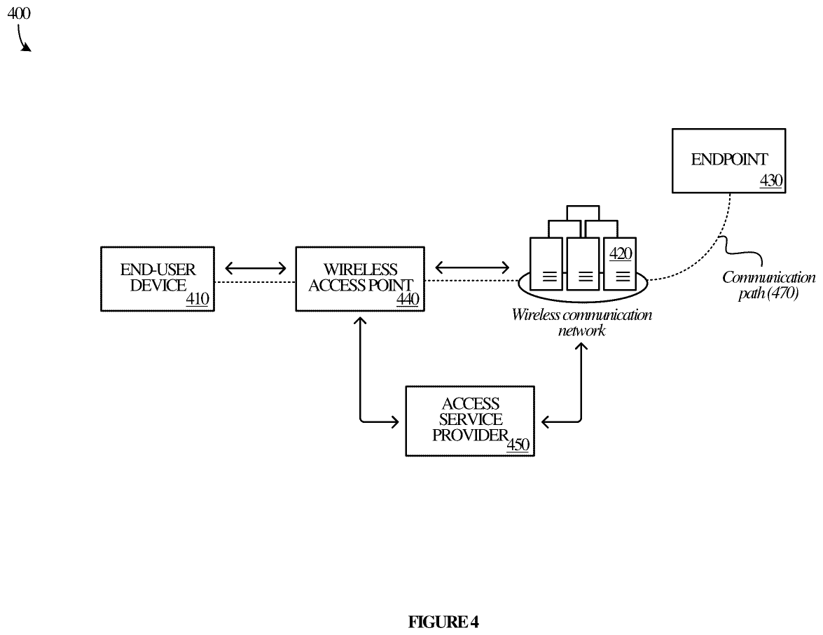

FIG. 4 illustrates operational environment 400 for connecting calls to an end-user device via a protected wireless access point in an implementation. Operational environment 400 includes end-user device 410, wireless access point 440, wireless communication network 420, access service provider 450, endpoint 430, and communication path 470 for calls between end-user device 410 and endpoint 430.

End-user device 410 is representative of a UE such as a mobile computing device, such as a smartphone, cellular phone, tablet computer, wearable device, Internet of Thing (IoT) device, or enhanced mobile broadband (eMBB) device, of which computing system 801 in FIG. 8 is representative. End-user device 410 includes processing circuitry for wireless communication including multimedia communication, e.g., IMS voice, text, video, or data transmission, hosted by a wireless communication network such as wireless communication network 420. End-user device 410 exchanges wireless communication signals with base stations or access nodes of wireless communication networks over radio frequency (RF) bands according to protocols such as Fifth Generation New Radio (5G-NR), 5G Advanced, 4G/LTE, 6G, Institute of Electrical and Electronic Engineers (IEEE) 802.11 (WiFi), Low-Power Wide Area Network (LP-WAN), Near-Field Communications (NFC), Code Division Multiple Access (CDMA), Frequency Division Multiple Access (FDMA), and Time Division Multiple Access (TDMA).

Wireless communication network 420 is representative of a communication network capable of using a Fifth Generation New Radio (5G-NR), 4G LTE, 6G, or other protocol to communicate with devices such as end-user device 410. In an implementation, wireless communication network 420 is representative of a service-based architecture (SBA) which includes network functions which constitute the control plane and user plane of a wireless communication network core, of which network data center 610 of FIG. 6 and network data center 710 of FIG. 7 are representative. Wireless communication network 420 includes a network function or functionality for enabling a call-back functionality for emergency calls from a PSAP or other third party via a wireless access point to an end-user device which is unauthenticated with respect to the wireless access point. Network functions of wireless communication network 420 are implemented on one or more suitable computing devices, of which computing device 801 of FIG. 8 is representative. Examples of suitable computing devices include server computers, blade servers, and the like. The network elements of wireless communication network 420 may be implemented in the context of one or more data centers in a co-located or distributed manner, or in some other arrangement.

Wireless access point 440 is representative of a computing device that enables access to a wireless network hosted by an access service provider, such as access service provider 450. Wireless access point 440 facilitates a wireless local area network (WLAN) to enable wireless data communication between connected client devices and a broader communication network, such as the Internet. Wireless access point 440 may operate by receiving data from a wired or fiber-based Internet connection, converting it into wireless signals using radio frequencies, and broadcasting these signals to allow client devices within range to access network resources. Wireless access point 440 may support protocols compliant with IEEE 802.11 standards, enabling interoperability and high-speed data transfer for client devices. Wireless access point 440 may include security protocols for protected access, such as WEP, WPA, WPA2, WPA3, and the like.

Access service provider 450 is representative of a network service provider that delivers Internet connectivity and network resources to client devices through a wireless access point such as wireless access point 440. Access service provider 450 may be an ISP or other entity that supplies access to a broader communication network, enabling wireless data communication for connected devices within a local area network (LAN). Access service provider 450 may include a centralized database for storing access credentials or tokens for authorizing access by a device such as end-user device 410 to a wireless access point such as wireless access point 440.

Endpoint 430 is representative of a computing device placing an IMS call to a mobile device such as end-user device 410. Endpoint 430 can include a PSAP returning a call to end-user device 410. Communication path 470 is representative of the transmission path of an IMS call between end-user device 410 and endpoint 430, such as an outgoing E911 call from end-user device 410 to endpoint 430 or a call-back by endpoint 430 to end-user device 410.

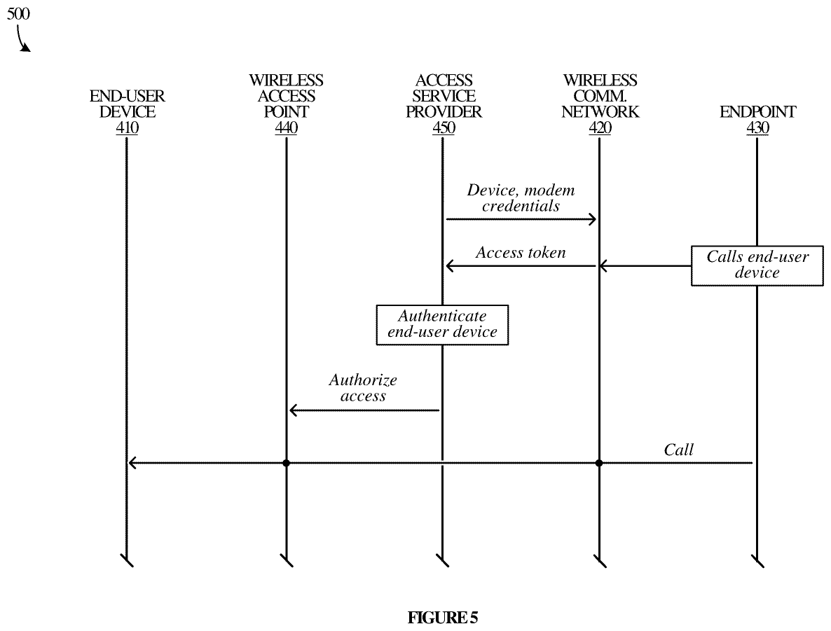

FIG. 5 illustrates workflow 500 for connecting calls to a UE via a protected wireless access point for wireless communication in an implementation as employed by elements of operational environment 400. Wireless communication network 420 receives a call from endpoint 430 to end-user device 410, however, end-user device 410 is not connected to wireless communication network 420. Wireless communication network 420 identifies wireless access point 440 (and associated access service provider 450) as an access point which may be able to wirelessly connect to end-user device 410. Identifying wireless access point 440 may be based on the last known location of end-user device 410, on historical access patterns of end-user device 410, etc. For the sake of illustration, it will be assumed that end-user device 410 lacks credentials (e.g., a password) for access to wireless access point 440.

Wireless communication network 420 sends a request to access service provider 450 to grant access to wireless access point 440 on behalf of end-user device 410 for routing the call from endpoint 430. In the request, the computing device of wireless communication network 420 includes an access token with the device keys or credentials for end-user device 410 and wireless access point 440. Upon receiving the access token from wireless communication network 420, access service provider 450 validates and authenticates end-user device 410 for network connectivity to wireless access point 440 on the basis of the validated credentials. In various implementations, the access token includes a timer so that access by end-user device 410 to wireless access point 440 is time-limited. With wireless connectivity established between end-user device 410 and wireless access point 440, wireless communication network 420 terminates the call through wireless access point 440 to end-user device 410.

To obtain the access token for establishing connectivity between end-user device 410 and wireless access point 440, a network function of wireless communication network 420, such as an ePDG, requests and receives the access token or access credentials from access service provider 450. The request for the access token may occur before the call from endpoint 430 is received. For example, wireless communication network 420 may maintain a database of such credentials with various ISPs which were previously negotiated and transferred. The access token or credentials grant access by end-user device 410 to wireless access point 440 for communications, such as receiving an emergency or high-priority call.

FIG. 6 illustrates exemplary wireless communication system 600 that serves a wireless end-user device such as User Equipment (UE) 601 based on policies. Wireless communication system 600 includes UE 601, WiFi Access Node (AN) 603, 5G new radio (5GNR) radio access node (RAN) 605, Interworking Function (IWF) 635, Access and Mobility Management Function (AMF) 634, Authentication Server Function (AUSF) 631, Unified Data Management (UDM) 632, Policy Control Functions (PCFs) 633, Session Management Function (SMF) 636, User Plane Function (UPF) 637, Uniform Data Repository (UDR) 638, ePDG 639, and Application Function (AF) 650. IWF 635 includes non-3GPP IWFs (N3IWFs) for providing untrusted non-3GPP access to network data center 610, such as access via a non-cellular access network.

Continuing with wireless communication system 600, wireless network slice 640 includes UPF 637 and SMF 636. DN 660 is representative of a data network, Internet access, third-party resource, or other endpoint such as a PSAP of an end-to-end communication path to/from UE 601.

FIG. 7 illustrates exemplary network data center 710, a network core of a wireless communication system, of which wireless network 120 of FIG. 1 is representative. Network data center 710 includes network function (NF) software 705, network function virtual layer 704, network function operating systems 703, network function hardware drivers 702, and network function hardware 701.

Network function software 705 of network data center 710 includes software for executing various network functions: IWF software 707, AMF software 709, UDM software 711, PCF software 713, SMF software 715, UPF software 717, and ePDG software 719. Other network function software, such as network repository function (NRF) software, are typically present but are omitted for clarity.

Network function virtual layer 704 includes virtualized components of network data center 710, such as virtual NIC 751, virtual CPU 752, virtual RAM 753, virtual drive 754, virtual software 755, and virtual GPU 756. Network operating systems 703 includes components for operating network data center 710, including kernels 761, modules 762, applications 763, and containers 764 for network function software execution. Network function hardware drivers 702 include software for operating network function hardware 701 of network data center 710, including network interface card (NIC) drivers 771 for network interface cards (NICs) 781, CPU drivers 772 for CPUs 782, RAM drivers 773 for RAM 883, flash/disk drive drivers 774 for flash/disk drives 784, data switch (DSW) drivers 775 for data switches 785, and drivers 776 for GPUs 786. Network interface cards 781 of network function hardware 701 include hardware components for communicating with WiFi access node 791, 5GNR access node 792, PCF 793, application server 794, and UPF 795.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements call connection process 806, which is (are) representative of the call connection processes discussed with respect to the preceding Figures, such as process 200 and workflows 300 and 500. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including call connection process 806) may be implemented in program instructions and among other functions may, when executed by processing system 802, direct processing system 802 to operate as described with respect to the various operational scenarios, sequences, and processes illustrated herein. For example, software 805 may include program instructions for implementing a call connection process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support call connection processes in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a computing device, comprising:
receiving a call to an end-user device that is proximate to, but unauthorized with respect to, a wireless access point associated with an access service provider;
requesting the access service provider to grant access through the wireless access point to the end-user device; and
connecting the call through the wireless access point to the end-user device.

2. The method of claim 1, wherein the call comprises a call-back to the end-user device from a public service answering point (PSAP) previously connected to the end-user device during an earlier call with respect to which the access service provider granted access through the wireless access point to the end-user device, wherein the end-user device initiated the earlier call, and wherein the earlier call comprised an emergency call.

3. The method of claim 2, wherein requesting the access service provider to grant access through the wireless access point to the end-user device comprises presenting access credentials to the access service provider, wherein the access credentials comprise a time-limited token established during the emergency call.

4. The method of claim 3, further comprising:
during the emergency call, obtaining, from the access service provider, connection information comprising a Media Access Control (MAC) address of the end-user device, a MAC address of the wireless access point, and an Internet Protocol (IP) address of the wireless access point and wherein the access credentials include the connection information.

5. The method of claim 1, wherein the call comprises an inbound call to the end-user device originating from a calling endpoint and wherein requesting the access service provider to grant access through the wireless access point to the end-user device comprises obtaining access credentials from the access service provider at a time of the inbound call.

6. The method of claim 5, wherein requesting the access service provider to grant access through the wireless access point further comprises:
identifying the wireless access point for routing the inbound call to the end-user device; and
presenting the access credentials to the access service provider, wherein the access credentials comprise a Media Access Control (MAC) address of the end-user device, a MAC address of the wireless access point, and an Internet Protocol (IP) address of the wireless access point.

7. The method of claim 6, further comprising identifying the wireless access point for routing the inbound call to the end-user device based on historical access information of the end-user device.

8. The method of claim 6, further comprising identifying the wireless access point for routing the inbound call to the end-user device based on a last known location of the end-user device.

9. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive a call to an end-user device that is proximate to, but unauthorized with respect to, a wireless access point associated with an access service provider;
request the access service provider to grant access through the wireless access point to the end-user device; and
connect the call through the wireless access point to the end-user device.

10. The computing apparatus of claim 9, wherein the call comprises a call-back to the end-user device from a public service answering point (PSAP) previously connected to the end-user device during an earlier call with respect to which the access service provider granted access through the wireless access point to the end-user device, wherein the end-user device initiated the earlier call, and wherein the earlier call comprised an emergency call.

11. The computing apparatus of claim 10, wherein to request the access service provider to grant access through the wireless access point to the end-user device, the program instructions direct the computing apparatus to present access credentials to the access service provider, wherein the access credentials comprise a time-limited token established during the emergency call.

12. The computing apparatus of claim 11, wherein the program instructions further direct the computing apparatus to:
during the emergency call, obtain, from the access service provider, connection information comprising a Media Access Control (MAC) address of the end-user device, a MAC address of the wireless access point, and an Internet Protocol (IP) address of the wireless access point and wherein the access credentials include the connection information.

13. The computing apparatus of claim 9, wherein the call comprises an inbound call to the end-user device originating from a calling endpoint and wherein to request the access service provider to grant access through the wireless access point to the end-user device, the program instructions further direct the computing apparatus to obtain access credentials from the access service provider at a time of the inbound call.

14. The computing apparatus of claim 13, wherein to request the access service provider to grant access through the wireless access point, the program instructions further direct the computing apparatus to:
identify the wireless access point for routing the inbound call to the end-user device; and
present the access credentials to the access service provider, wherein the access credentials comprise a Media Access Control (MAC) address of the end-user device, a MAC address of the wireless access point, and an Internet Protocol (IP) address of the wireless access point.

15. The computing apparatus of claim 14, wherein the program instructions further direct the computing apparatus to identify the wireless access point for routing the inbound call to the end-user device based on historical access information of the end-user device.

16. The computing apparatus of claim 14, wherein the program instructions further direct the computing apparatus to identify the wireless access point for routing the inbound call to the end-user device based on a last known location of the end-user device.

17. A method of operating a computing device, comprising
receiving a call initiated by an end-user device from a wireless access point associated with an access service provider;
presenting access credentials to the access service provider in a request to grant continuing access through the wireless access point to the end-user device;
receiving an inbound call to the end-user device; and
connecting the call through the wireless access point to the end-user device.

18. The method of claim 17, wherein the inbound call comprises a call-back to the end-user device from a public service answering point (PSAP) previously connected to the end-user device during the call initiated by the end-user device, wherein the call initiated by the end-user device was an emergency call.

19. The method of claim 18, further comprising obtaining, from the access service provider during the call initiated by the end-user device, access credentials for requesting the continuing access.

20. The method of claim 19, wherein the access credentials comprise a time-limited token established during the emergency call.
